(19) United States
(12) Patent Application Publication
(10) Pub. No.: US 2010/0307363 A1
(43) Pub. Date: Dec. 9, 2010

(54) ULTRA-HIGH VELOCITY PROJECTILE IMPACT SENSOR

(75) Inventor: Ehud CHISHINSKI, Nofit (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: RAFAEL ADVANCED DEFENSE SYSTEMS LTD., Haifa (IL)

(21) Appl. No.: 12/791,886

(22) Filed: Jun. 2, 2010

(30) Foreign Application Priority Data
Jun. 3, 2009 (IL) 199142

(51) Int. Cl. F42C 19/07; G01N 3/30

(52) U.S. Cl. 102/216; 73/12.05

(57) ABSTRACT

An apparatus for detecting the impact of an ultra-high velocity projectile includes: a projectile; at least one optical fiber attached to at least a first area of the projectile; a light source coupled to the optical fiber supplying light into the optical fiber; and a monitor coupled to optical fiber configured to monitor the light in one optical fiber and positioned in a second area of the projectile. A method for operating a circuit in response to a shockwave of ultra-high velocity, includes the steps of deploying at least one optical fiber in a first area in the path of an ultra-high velocity shockwave; coupling a light source to the optical fiber, the light source supplying a light into the optical fiber; and deploying a monitor coupled to the optical fiber to: monitor the light in the optical fiber to detect a change in the light; and positioned in a second area further along the path of the shockwave.

This patent application claims priority of Israel Patent Application No. 199142 filed Jun. 3, 2009, which is incorporated herein by reference in its entirety.

### FIELD OF THE INVENTION

The present invention generally relates to the field of sensors, and in particular to the area of an ultra-high velocity projectile self-sensing an impact with another object.

### BACKGROUND OF THE INVENTION

Shock and impact sensors are devices that detect sudden movements, changes, or severe impacts at a predetermined level and indicate whether that level has been exceeded. Impact sensors are used in applications where it is desirable to know when an impact has occurred. In an ultra-high velocity impact, the relative velocities of the colliding objects can be about 5000 meters per second (m/s) or higher which is about the speed of sound in metal. The speed of sound through the metal construction materials of a projectile limits the propagation speed of the shock wave from an impact through the projectile. Under these conditions, the normal working assumptions of conventional technologies used in the art break down. An example of an application that uses this ultra-high velocity is an anti-projectile projectile. During the final flight stage of the projectile, high velocities are used to improve the accuracy and the efficacy of a successful engagement. In the case where it is desirable for a projectile to send a notification that it has had an impact, this event must be sensed, analyzed, and transmitted after the impact has occurred, but before the projectile is destroyed by the impact. The impact sensor of the projectile needs to be able to detect that an impact has occurred before the sensor is destroyed. Related to this, the sensor must be able to trigger a notification message be sent, and the message sent before the transmitter is destroyed.

Conventional techniques use electrical sensors to detect an impact. Conventional techniques require that the shock from the impact arrive at the sensor and the sensor actuates before the sensor is destroyed. If the electrical sensor is positioned at the anticipated area of impact, the sensor will be destroyed on impact, hence unable to send an impact notification message. Another option for an electrical sensor is to position the sensor in an area of the projectile that is not near the area of impact and detect an indication of the impact. This method is not sufficient at ultra-high velocities because the velocity of the destructive shock wave through the projectile structure exceeds the speed of the sound in the materials of which the projectile is constructed, so the sensor is destroyed before being able to detect the impact.

Another option is to use a conductive circuit positioned at the anticipated area of impact and an electrical sensor positioned in a second area of the projectile, away from the anticipated area of impact. An electrical signal, such as a voltage, is supplied through the conductive circuit. The sensor monitors the conductive circuit for a change in the signal being supplied to the circuit. When the projectile impacts, the conductive circuit is destroyed before the sensor is destroyed. When the sensor measures a change in the signal being monitored, the change can be analyzed, and if this change indicates that the circuit has been destroyed, the sensor can trigger an impact notification message. This technique is known in the art and is used to measure impacts at velocities about 1000 m/s, which is much lower than speed of sound in the materials of which the projectile is constructed. At these velocities, the impact results in damage to the conductive circuit, for example breaking of the conductivity of the circuit. The corresponding change, in this example loss of signal in the circuit, is measured by the sensor, and an impact message can be sent before the sensor is destroyed.

This technique of using a conductive circuit is not sufficient to detect ultra-high velocity projectile impacts because of the type of destruction resulting from the impact. When there is an ultra-high velocity projectile impact, the construction material of the projectile transitions to an indefinite state. The unpredictable effects of an ultra-high velocity impact on electrical circuitry may be because of the possible formation of plasma, or other unpredictable physical phenomena, due to the velocity of the impact exceeding the speed of sound in the material. The operation of a conductive circuit under these conditions cannot be predicted reliably. The destruction of a conductive circuit at ultra-high velocities does not provide a reliable change in the signal. For example, the conductive circuit may short instead of breaking, or may have a non-repeatable response.

There is therefore a need for an apparatus and method to provide a reliable sensor for ultra-high velocity projectile impacts. The current invention describes such an apparatus and method.

### SUMMARY

According to the teachings of the present embodiment there is provided an apparatus for detecting the impact of an ultra-high velocity projectile including: a projectile; at least one optical fiber attached to at least a first area of the projectile; a light source coupled to the at least one optical fiber supplying light into the at least one optical fiber; and a monitor coupled to the at least one optical fiber configured to monitor a property of the light in the at least one optical fiber and positioned in a second area of the projectile.

In an optional embodiment, the projectile operates at ultra-high velocity when intercepting a target. In another optional embodiment, the monitor is operationally connected to a transmitter. In another optional embodiment, the monitor is operationally connected to a detonator, the detonator configured for actuating the detonation of a given warhead. In another optional embodiment, the at least one optical fiber is joined to a substrate suitable for adhering to the projectile. In another optional embodiment, the projectile includes a channel for holding the optical fiber.

According to the teachings of the present embodiment there is provided a method for operating a circuit in response to a shockwave of ultra-high velocity, including the steps of: deploying at least one optical fiber in a first area in the path of an ultra-high velocity shockwave; coupling a light source to the at least one optical fiber, the light source supplying light into the at least one optical fiber; and deploying a monitor coupled to the at least one optical fiber to: monitor the light in the at least one optical fiber to detect a change in a property of the light; and positioned in a second area further along the path of the shockwave.

In an optional embodiment, the method further includes the monitor initiating a message trigger. In another optional embodiment, the method further includes the monitor actuating the detonation of a given warhead.

### BRIEF DESCRIPTION OF FIGURES

The embodiment is herein described, by way of example only, with reference to the accompanying drawings, wherein:

FIG. 1 is a diagram of a projectile that can travel at ultra-high velocities.

FIGS. 2A-2D are schematic examples of some options for optical fiber layout.

FIG. 3, a flowchart of a method for operating a circuit in response to a shockwave of ultra-high velocity.

### DETAILED DESCRIPTION

The present invention is an apparatus and method for detecting the impact of an ultra-high velocity projectile impact. The principles and operation of this apparatus and method according to the present implementation may be better understood with reference to the drawings and the accompanying description.

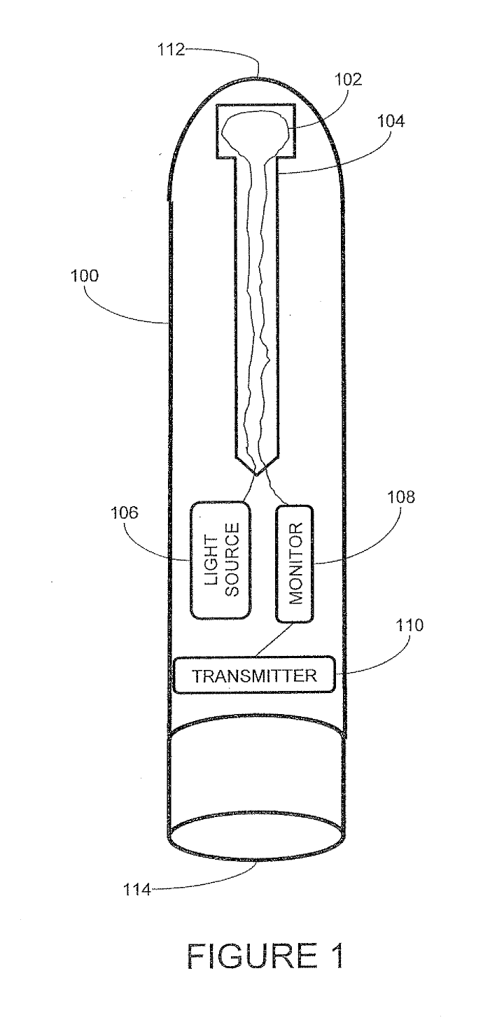

Referring now to the drawings, FIG. 1 is a diagram of a projectile 100 that can travel at ultra-high velocities. In the context of this invention, the term ultra-high velocity refers to collisions occurring at relative velocities above about 1500 m/s. When the projectile collides with a target, the impact results in the destruction of the projectile. When a projectile strikes a target, it is desirable to know that the impact occurred. In this case, the projectile needs to send a notification that it has had an impact after the impact has occurred, but before the projectile is destroyed by the impact. As described in the background section of this document, conventional solutions are not sufficient to provide this capability.

One embodiment of a sensor capable of detecting an ultra-high velocity projectile impact uses an optical fiber 102 optionally joined to a substrate 104. One end of the optical fiber 102 is connected to a light source 106. The other end of the optical fiber 102 is connected to a monitor 108. The monitor is optionally coupled to a transmitter 110. When the end of the projectile 112 impacts a target, the resulting destruction of the optical fiber causes the intensity of the light in the optical fiber to decrease. This decrease can be detected at the monitor 108 that then sends a message to the transmitter 110. The transmitter can transmit a message from the projectile in accordance with the specific implementation of the system of the projectile.

In the described embodiment, optical fiber is used to provide a reliable sensor for ultra-high velocity impacts. Optical fibers in general are known in the art, and typically comprise a transparent core of a suitable glass or plastic material that is carried within a relatively thin cylindrical cladding having an index of refraction less than the refractive index of the core. When a light signal such as a collimated beam generated by a laser is focused upon one end of the optical fiber, the optical fiber core functions as a waveguide to transmit, or propagate, the light signal through the core with relatively small internal intensity losses or transmission or the signal to the cladding. Less expensive optical fibers can be constructed from plastic and less expensive light sources, such as light-emitting diodes (LEDs), can be optionally be used.

Unlike conductive metal wires, optical fibers are generally non-conductive. This property of fiber optics overcomes a limitation of using a conductive circuit under the conditions of an ultra-high velocity projectile impact. As mentioned in the background section of this document, during an ultra-high velocity projectile impact the operation of a conductive circuit cannot be predicted reliably. A conductive circuit may short maintaining conductivity during impact, surge potentially damaging the monitor, or produce another response that is not predictable and/or repeatable. An optical fiber provides a predictable response under the conditions of an ultra-high velocity projectile impact. When the optical fiber is intact, it propagates light and when the fiber is damaged, the light decreases. In the case where the optical fiber is broken or destroyed or even under some conditions of shock and vibration, the light cannot propagate or propagation is decreased through the optical circuit

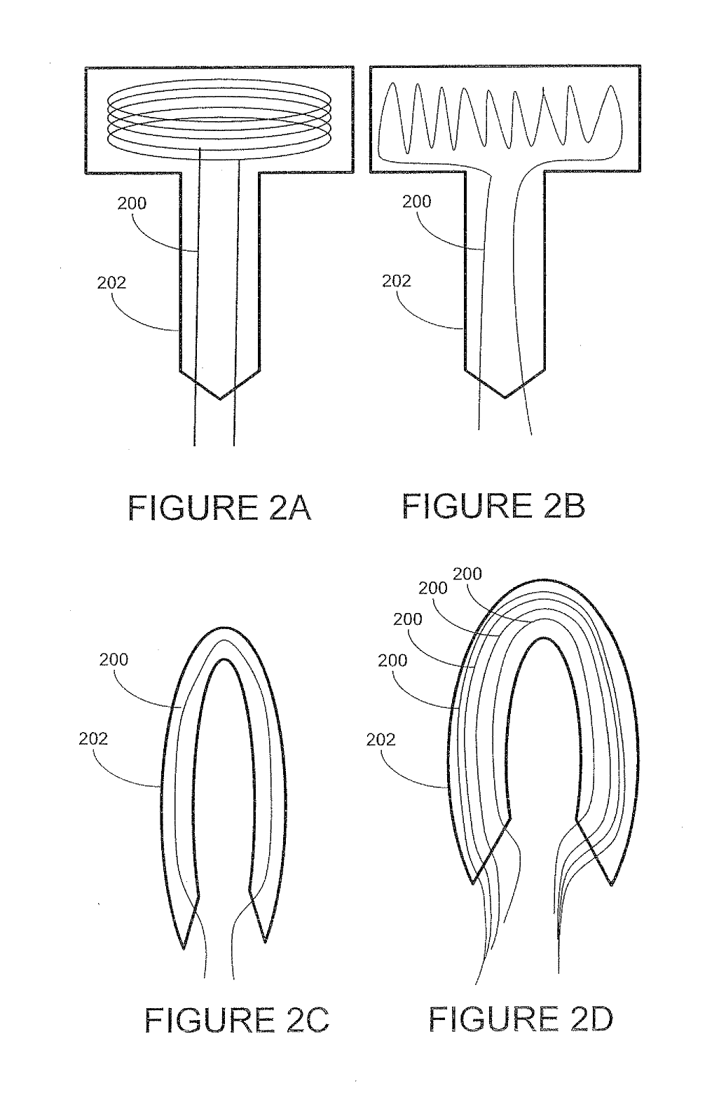

In this embodiment, at least one optical fiber is attached to a first area of the projectile 100. This first area is the area of the projectile that is designed to be near the first point of impact 112 when the projectile strikes the target. The one or more optical fibers can be attached in a variety of configurations, as is discussed in reference to FIG. 2A-2D.

A light source 106 is coupled to the optical fiber and provides light with known properties into a first end of the optical fiber. The provided light propagates through the optical fiber and can be detected by a monitor that is coupled to the second end of the optical fiber. In an optional embodiment, the monitor and the light source are provided as separate devices. In another optional embodiment, both the light source and the monitor can be coupled to the same end of the optical fiber. In this single-ended configuration, the monitor monitors the optical fiber to measure the reflected light. Other configurations of the light source, monitor, and connections will be obvious to one skilled in the art.

Monitors can be selected and configured to detect a variety of parameters of the light signal being provided through the optical fiber. Measurable parameters include the intensity, frequency, and phase of the light. An optional embodiment uses more than one monitor coupled to one or more optical fibers. In some implementations, it may be desirable to use more than one monitor to detect changes in the provided light, for example, to provide redundancy. Multiple monitors can be coupled to the same optical fiber, or each monitor can be coupled to one or more different optical fibers. A plurality of monitors may each monitor the same parameter, or each can measure a different parameter of the provided light. Other options will be obvious to one skilled in the art.

The monitor is positioned in a second area of the projectile. This second area is the area of the projectile that is designed to be farthest away from the first point of impact 112 when the projectile strikes the target. In FIG. 1, this second area is at the end of the projectile noted 114.

When a projectile strikes a target, the impact will be at a first area of the projectile 112. Depending on the design of the projectile, this first area will begin to crush, collapse, fragment, explode, or similar. Given the ultra-high velocity of the impact, high energies are involved and the materials at the first area of the projectile begin to transition to an indefinite and/or unpredictable state. The optical fiber in the first area is possibly deformed, then destroyed, resulting in an interruption to the light propagating through the optical fiber. The shockwave from the impact begins to travel through the projectile from the first area of impact 112 toward the second area 114 farther away from the impact. The ultra-high velocity impact of a projectile with a target occurs at a relative velocity of about 1500 m/s or greater, although the relative velocity can be about 5000 m/s. In one implementation, the velocity of the projectile is about 1500 m/s or greater. In an optional implementation, the velocity of the projectile is less than 1500 m/s and the velocity of the target is greater than 1500 m/s, with a relative velocity of about 1500 m/s or greater. The velocity of light is significantly faster, about 300,000,000 m/s, depending on the type of optical fiber. This difference in velocities allows the monitor to detect a change in the light at the second area before the shockwave reaches the second area and damages or destroys the monitor.

When the monitor detects a significant change in the light, the monitor can trigger a function, this function being dependant on the design of the sensor. In one implementation, the monitor is operationally connected to a transmitter. This transmitter is also located in the second area of the projectile. When triggered, the transmitter can transmit a designated signal from the projectile. One example of a signal is a message that the projectile has struck a target. Other information can be transmitted depending on the design of the projectile system. Examples of information include time, location, status, and velocity. Other signals and messages will be obvious to one skilled in the art.

Practical operation of the apparatus includes avoiding false triggering. It is desirable to trigger when the projectile strikes a target, as compared to triggering while the projectile is being handled or is in flight. During projectile flight, it is possible for the first area of the projectile to deform and affect the optical fiber. Other conditions during flight may also affect the optical fiber. The specific effects on the optical fiber depend on the specific design and use of the projectile. It is also possible that the fiber will not be destroyed on impact, or that the fiber will deform prior to destruction. Typical operating parameters can be predicted using theoretical analysis, measured during experimentations, and measured during testing. Using the typical operating parameters of the optical fiber circuit, it is possible to trigger when these parameters are outside given thresholds. The monitor is configured to account for the specific operating conditions of the projectile and use this information to trigger appropriately. An example of an implementation is to monitor the intensity of the provided light and trigger when the intensity drops below a given threshold for a given length of time.

An alternative implementation of monitoring, triggering, and transmission includes transmitting information during projectile flight. This information during flight is useful during experimentation and testing, as well as during operation. Sensor information during flight can be used to establish the normal operating parameters of the sensor. In addition to time, location, status, and velocity other parameters of interest can include the intensity of the light and other measurable parameters being monitored from the optical fiber, changes in parameters, and when parameters exceed or drop below given thresholds. Transmitting information during flight can allow the projectile system to monitor the progress of the projectile and provide pre-strike location and status information. Then on impact, the system can transmit an impact message, and then continue to transmit information until the transmitter is destroyed. Other implementations will be obvious to one skilled in the art.

In an optional embodiment, the propulsion system for propelling the projectile is not part of the projectile. In such an embodiment, the projectile is part of an interception system configured for operating at ultra-high velocities when intercepting a target. The projectile is designed for striking other projectiles at ultra-high velocities to improve the efficacy of a successful engagement.

In another optional embodiment, the projectile is a missile having a propulsion system capable of bringing the missile to ultra-high velocities. A missile is a projectile that has the capability for self-propulsion. In an embodiment where the missile is an intercepting missile, the intercepting missile is designed to track and strike other projectiles. An intercepting missile can use ultra-high velocities during the final flight segment to improve the accuracy and efficacy of a successful engagement.

In an optional embodiment, one of the functions the monitor can trigger is the detonation of a given warhead. In this embodiment, the monitor is operationally connected to a detonator. When the monitor detects the impact of the projectile, the monitor triggers the detonator. The detonator is operationally connected to a warhead. When the detonator receives a trigger from the monitor, the detonator actuates the detonation of the warhead.

In one embodiment, the optical fiber 102 is joined with a substrate suitable for adhering to a projectile 104. The substrate facilitates attaching the optical fiber to the projectile 100. Joining the optical fiber with a substrate facilitates handling the cable and deployment in the projectile. Bare optical fibers are fragile and hazardous to handle. They may be coated with one or more layers of protective flexible coatings or embedded in flexible plastic ribbons. Other techniques are known in the art. The substrate may include a surface containing an adhesive suitable for attaching to the projectile, or the substrate may be otherwise prepared to facilitate attaching to the desired areas of the projectile.

Referring to FIGS. 2A-2D, schematic examples of some options for optical fiber layout, the optical fiber may be deployed in a variety of configurations. FIGS. 2A-2C are examples of laying out the cable on the substrate in several optional configurations. FIG. 2D is an example of deploying more than one optical fiber cable on a substrate. It is also possible to use more than one substrate. Specific implementations depend on the requirements for use, and additional options will be obvious to one skilled in the art.

In one implementation, the optical fiber is joined to a flexible plastic strip. A portion of the flexible plastic strip can be adhered inside the projectile to the first impact area. The remaining portions of the strip can be adhered to other areas of the projectile, for example the sides, and provide a circuit for the optical fiber to couple to the monitor in a second area of the projectile.

In an alternative implementation, the projectile can be designed with a channel for holding the optical fiber. In this context, a channel is a route through which anything passes or progresses. For example, the channel can be cut into the inside wall of the projectile so the optical fiber is placed below the inside surface or the projectile, or the channel can be a structure constructed above the inside surface of the projectile. The channel facilitates placement of the optical fiber in the projectile. The optical fiber can be placed in the channel to facilitate positioning at least a portion of the optical fiber in the first impact area of the projectile, and providing a path for the optical fiber to the monitor in a second area of the projectile. Other implementations for deployment of the optical fiber in the appropriate locations are possible and will be obvious to one skilled in the art.

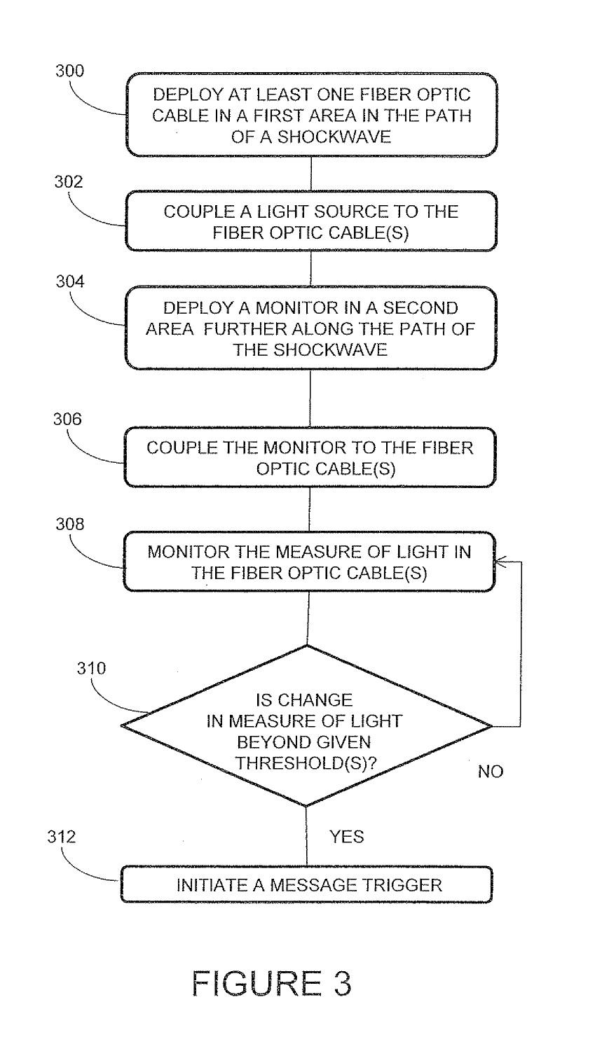

Refer to FIG. 3, a flowchart of a method for operating a circuit in response to a shockwave of ultra-high velocity. An example of an ultra-high velocity shockwave is the shockwave that propagates through an ultra-high velocity projectile when the projectile strikes a target. Another example of an ultra-high velocity shockwave is the shockwave created by an explosion, such as the detonation of the chemical explosive trinitrotoluene (TNT) which has a detonation velocity of 6,900 m/s.

The first step shown in block 300 is to deploy at least one optical fiber in a first area in the path of the shockwave. A light source is coupled to the optical fiber, shown in block 302. The light source supplies light into at least one optical fiber. A monitor is deployed in a second area further along the path of the shockwave, shown in block 304. The monitor is coupled to the optical fiber(s), shown in block 306. The monitor is configured to monitor the light in the optical fiber(s), shown in block 308. While the monitored light is within given operating parameters, the monitor continues to monitor the light from the optical fiber, shown in block 310. While monitoring, the monitor may optionally provide measured parameters and other operating information to the system. When the monitor detects that one of the properties of the light being measured is beyond the given threshold(s), shown in block 310, it can optionally initiate a message trigger, shown in block 312. In an optional implementation, initiating a message trigger actuates the detonation of a warhead.

Note that in this method, the order of deployment and coupling of components is non-limiting. Either the light source or monitor can be coupled first to the optical fiber. This coupling can be done before deployment of the optical fiber.

The current invention is not limited to use with ultra-high velocity impacts. The current invention can also be used to detect impacts at lower velocities, including: supersonic, above 340 m/s, conventional, on the order of 200 m/s, and highway speeds, on the order of 30 m/s. In these cases, the monitor is configured with the typical operating parameters of the specific embodiment.

It will be appreciated that the above descriptions are intended only to serve as examples, and that many other embodiments are possible within the scope of the present invention as defined in the appended claims.

What is claimed is:

1. An apparatus for detecting the impact of an ultra-high velocity projectile comprising:
(a) a projectile;
(b) at least one optical fiber attached to at least a first area of said projectile;
(c) a light source coupled to said at least one optical fiber supplying light into said at least one optical fiber; and
(d) a monitor coupled to said at least one optical fiber configured to monitor the light in said at least one optical fiber and positioned in a second area of said projectile.

2. The apparatus of claim 1 wherein said projectile is part of an interception system configured for operating at ultra-high velocities when intercepting a target.

3. The apparatus of claim 1 wherein said projectile is a missile, said missile having a propulsion system capable of bringing the missile to ultra-high velocities.

4. The apparatus of claim 1 wherein said monitor is operationally connected to a transmitter.

5. The apparatus of claim 1 wherein said monitor is operationally connected to a detonator, said detonator configured for actuating the detonation of a given warhead.

6. The apparatus of claim 1 wherein said at least one optical fiber is joined to a substrate, and wherein said substrate is adhered to said projectile.

7. The apparatus of claim 1 wherein said projectile includes a channel for holding said optical fiber.

8. A method for operating a circuit in response to a shockwave of ultra-high velocity, comprising the steps of:
(a) deploying at least one optical fiber in a first area in the path of an ultra-high velocity shockwave;
(b) coupling a light source to said at least one optical fiber, said light source supplying light into said at least one optical fiber; and
(c) deploying a monitor coupled to said at least one optical fiber to:
(i) monitor the light in said at least one optical fiber to detect a change in said light; and
(ii) positioned in a second area further along the path of said shockwave.

9. The method of claim 8 further comprising said monitor initiating a message trigger.

10. The method of claim 8 further comprising said monitor actuating the detonation of a given warhead.
